(19) United States
(12) Patent Application Publication
(10) Pub. No.: US 2015/0017605 A1
(43) Pub. Date: Jan. 15, 2015

(54) DENTAL IMPLANT WITH HIGH COMBINING STABILITY

(71) Applicant: TAIWAN SHAN YIN INT'L CO., LTD., Kaohsiung City (TW)

(72) Inventors: KOU-TSAIR SU, KAOHSIUNG CITY (TW); YU-JUNG SU, KAOHSIUNG CITY (TW)

(21) Appl. No.: 13/941,662

(22) Filed: Jul. 15, 2013

(51) Int. Cl. A61C 8/00

(52) U.S. Cl. CPC A61C 8/0025
USPC 433/174

(57) ABSTRACT

A dental implant comprises a shank and a threaded section spirally disposed on the shank. The shank includes a first section extending from a first end toward a second end of the shank and a second section connecting the first section and extending to the second end. A shank diameter of a connecting part where the first and the second sections are connected is smaller than that of the second section, whereby the subject configuration increases an implant-fastening feel of dentists and an initial implanting stability efficiently while implanting the dental implant into an alveolar bone. When the dental implant is enclosed by a growth of the bone, the second section is firmly fixed by the bone to prevent the dental implant from loosening due to an inverse torque derived from the mastication and allow it to be firmly embedded in the bone to increase the combining stability.

### BACKGROUND OF THE INVENTION

1. Field of the Invention

The present invention relates to a dental implant, particular to a dental implant with high combining stability for being implanted into the alveolar bone of the human body.

2. Description of the Related Art

Referring to FIG. 1, a conventional dental implant includes a shank 11 and a threaded portion 12 spirally disposed on the shank 11. Wherein, a first end 111 and a second end 112 opposite to the first end 111 are respectively defined on two sides of the shank 11. A slot 1111 is formed on the first end 111 to allow an abutment (not shown) to install and fix thereon. The second end 112 is formed into an arch shape. Further, the shank diameter of the shank 11 is gradually decreased from the first end 111 to the second end 112. In an implanting operation, the dental implant 1 is firstly put into a bore pre-drilled on an alveolar bone. Then, the second end 112 is applied to separate the gums and nerves in the vicinity of the alveolar bone, and the threaded portion 12 is applied to drill into the alveolar bone, thereby fixing the dental implant 1 onto the alveolar bone.

However, some problems still exist in the conventional design. Due to the taper-shaped shank and the pre-drilled bore on the alveolar bone, the wall of the bore and the threaded portion 12 at the front and middle parts of the shank 11 are not well contacted, which leads to a poor feel of fastening the dental implant of the dentist and a poor stability of the initial implanting status. In addition, outer forces such as linear forces and torques imparting to the teeth in the oral cavity are defined according to change of the mastication direction. In other words, the torque derived from the mastication keeps affecting the teeth, which causes the dental implant 1 to generate an inverse rotation opposite to the drilling direction of the dental implant 1 easily. When the dental implant 1 is inversely rotated, the taper-shaped shank renders the alveolar bone unable to resist the inverse rotation of dental implant 1. Thus, the dental implant 1 may be withdrawn from the alveolar bone along an opposite direction, loosened, and even dropped off, which still requires improvements.

### SUMMARY OF THE INVENTION

The object of the present invention is to provide a dental implant with high combining stability, which increases the feel of fastening the implant of the dentist and the initial implanting stability efficiently and fixes the dental implant onto the alveolar bone firmly for enhancing the combining stability.

The dental implant with high combining stability in accordance with the present invention comprises a shank and a threaded section spirally disposed on the shank. The shank has a first end and a second end opposite to the first end. The shank further includes a first section extending from the first end toward the second end and a second section connecting the first section and extending to the second end. A connecting part where the first section and the second section are connected has a shank diameter smaller than a shank diameter of the second section. Accordingly, by having the second section with a larger shank diameter greater than that of the connecting part, the threaded section on the second section can be densely combined with and embedded into a wall of a pre-drilled bore of an alveolar bone during the entire implanting operation, whereby when the dental implant is driven to be implanted into the alveolar bone, the implant-fastening feel of the dentist is largely increased and satisfied, and the stability of the initial implanting is efficiently increased. When the dental implant is further enclosed by a growth of the alveolar bone, the second section is still densely fixed by the alveolar bone during the mastication even though an inverse torque causing the dental implant to be oppositely withdrawn is generated. Therefore, the present invention allows the dental implant to be firmly embedded in the alveolar bone, thereby increasing a combining stability.

Preferably, a third section having a plurality of small threads spirally disposed thereon is disposed between the first end and the first section.

Preferably, a maximum shank diameter of the third section are connected is larger than a shank diameter of a join part where the third section and the first section are connected.

Preferably, the first section includes a first portion with a gradual-enlarging shank diameter and a second portion with a gradual-contracting shank diameter disposed between the first portion and the second section. The first portion may be connected to the third section. A shank diameter of a junction part where the first portion and the second portion are connected is larger than shank diameters of the first portion and the second portion.

Preferably, a shank diameter of the first section is gradually decreased toward a direction of the second section.

Preferably, a shank diameter of the second section is gradually increased toward a direction of the second end.

The advantages of the present invention over the known prior arts will become more apparent upon reading the following descriptions in junction with the accompanying drawings.

### BRIEF DESCRIPTION OF THE DRAWINGS

FIG. 1 is a schematic view showing a conventional dental implant;

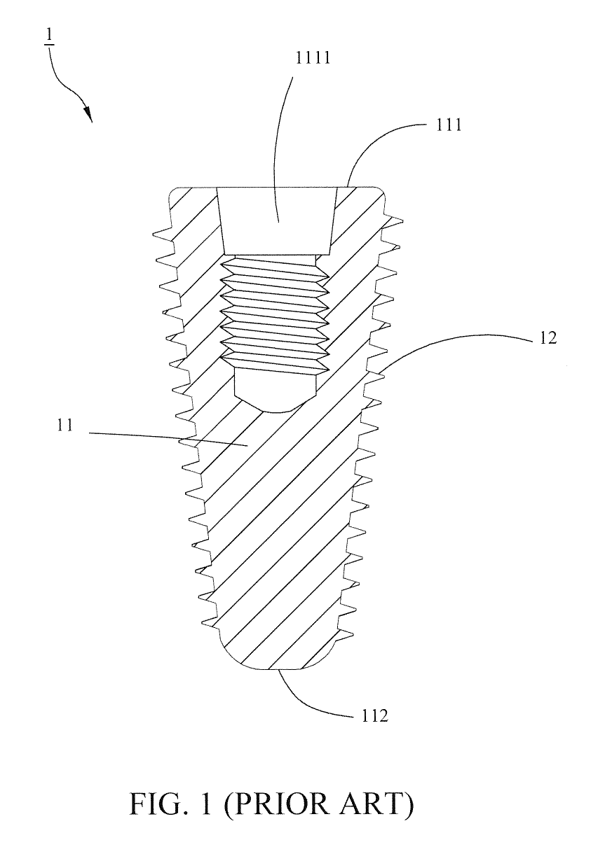

FIG. 2 is a schematic view showing a variation of a first preferred embodiment of the present invention;

FIG. 3 is a schematic view showing a further variation of the first preferred embodiment of the present invention;

FIG. 4 is a schematic view showing an operation of the first preferred embodiment of the present invention; and

FIG. 5 is a schematic view showing a second preferred embodiment of the present invention.

### DETAILED DESCRIPTION OF THE PREFERRED EMBODIMENTS

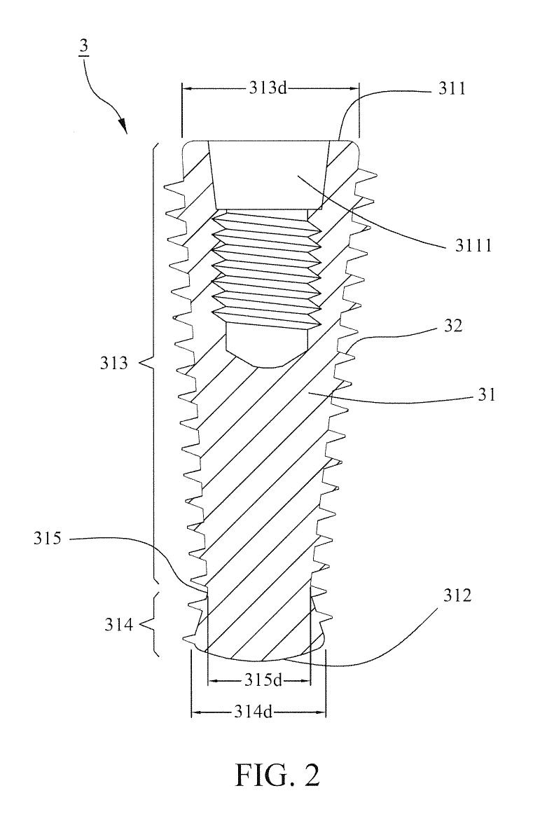

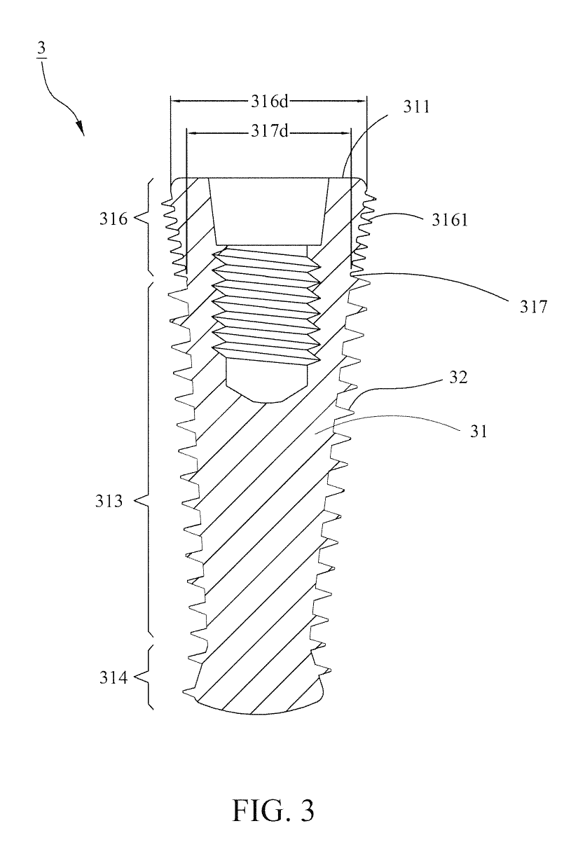

Referring to FIG. 2 shows a first preferred embodiment of a dental implant 3 with high combining stability of the present invention. The dental implant 3 comprises a shank 31 and a threaded section 32 spirally disposed on the shank 31. Wherein, a first end 311 and a second end 312 opposite to the first end 311 are respectively formed at two sides of the shank 31. The shank 31 further includes a first section 313 extending from the first end 311 toward the second end 312 and a second section 314 connecting the first section 313 and extending to the second end 312. The first section 313 and the second section 314 are connected at a connecting part 315, and a shank diameter 315d of the connecting part 315 is smaller than a shank diameter 314d of the second section 314. In this preferred embodiment, a shank diameter 313d of the first section 313 is gradually decreased toward a direction of the second section 314, and a shank diameter 314d of the second section 314 is gradually increased toward a direction of the second end 312. Further, in this preferred embodiment, a slot 3111 is preferably recessed into the first end 311 so that an abutment (not shown) is able to be fixed and installed onto the slot 3111. The second end 312 can be formed into an arch shape as illustrated to decrease injuries to the nerves and gums in the pursuance of the implanting operation. Alternatively, the shank 31 can further comprise a third section 316 disposed between the first end 311 and the first section 313 as shown in FIG. 3, and a plurality of small threads 3161, preferably with the pitch and thread diameter smaller than those of the threaded section 32, are spirally disposed on the third section 316. Also, the third section 316 and the first section 313 are connected at a join part 317, and a maximum shank diameter 316d of the third section 316 is preferably larger than a shank diameter 317d of the join part 317. In this preferred embodiment, the configuration without the third section 316 as shown in FIG. 2 is herein adopted as an example in the following description related to the operation.

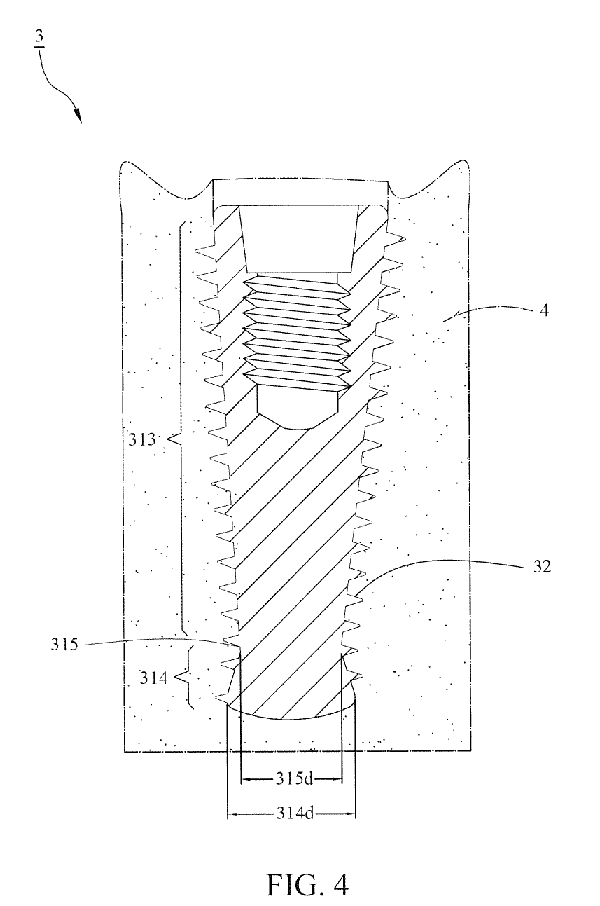

Referring to FIG. 2 and FIG. 4, in an implanting operation, a bore (not shown) is initially formed on an alveolar bone 4. By means of the shank diameter 314d of the second section 314 larger than the shank diameter 315d of the connecting part 315, the threaded section 32 of the second section 314 can be driven to densely contact with and embed into an wall of the bore during the entire drilling action, which not only provides an increase of the feel of fastening the dental implant for the dentist but facilitates an increase of the initial implanting stability when the threaded section 32 of the dental implant 3 is firmly positioned onto the bore wall of the alveolar bone 4 of the human body. When the alveolar bone 4 grows for a period of time, the dental implant 3 will be enclosed or wrapped by the alveolar bone 4. In this manner, the alveolar bone 4 is still densely combined with the dental implant 3 by using the second section 314 with the larger shank diameter 314d which firmly and densely meets the bore wall and using the connecting part 315 with the smaller shank diameter 315d which thus forms a concave space between the first section 313 and the second section 314 to allow the reborn alveolar bone 4 to fill the space, thereby the dental implant 3 can be naturally wedged into the alveolar bone 4. Even though an inverse torque is generated during the mastication, the alveolar bone 4 subjects the second section 314 to a fixing resistance in order to prevent the dental implant 3 from being withdrawn and dropped off from the alveolar bone 4. Therefore, the dental implant 3 can be firmly positioned onto the alveolar bone 4, thereby increasing the steadiness of combination and attaining a high combining stability.

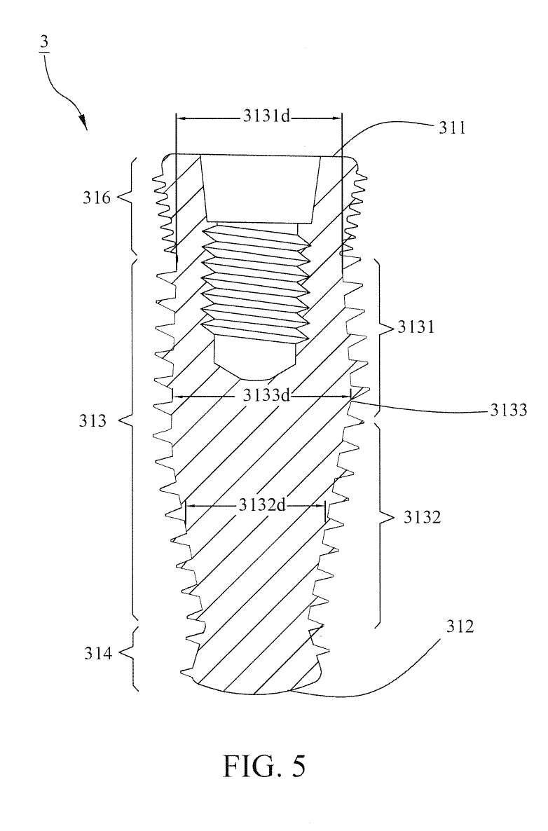

Referring to FIG. 5 shows a second preferred embodiment of a dental implant 3 with high combining stability of the present invention. The dental implant 3 still comprises the same concatenation of correlated elements as that of the first preferred embodiment. Differently, this preferred embodiment is described by having a third section 316 disposed between the first end 311 and the first section 313, characterized in that the first section 313 further includes a first portion 3131 with a gradual-enlarging shank diameter 3131d connected to the third section 316 and a second portion 3132 with a gradual-contracting shank diameter 3132d disposed between the first portion 3131 and the second section 314. The first portion 3131 and the second portion 3132 are connected at a junction part 3133, and a shank diameter 3133d of the junction part 3133 is larger than shank diameters 3131d, 3132d of the first portion 3131 and the second portion 3132. Accordingly, when the dental implant 3 is surrounded by the reborn alveolar bone 4, not only the second section 314 but the first portion 3131 can be densely and firmly positioned onto the alveolar bone 4, thereby preventing the dental implant 3 from loosening efficiently, fixing the dental implant 3 onto the alveolar bone 4, and increasing the combining stability efficiently.

To sum up, the present invention takes advantage of the second section of the shank which has a shank diameter larger than a shank diameter of the connecting part where the first and the second sections are connected to increase an implant-fastening feel of the dentist and enhance an initial implanting stability. When the alveolar bone is reborn to cover the dental implant, the alveolar bone provides the second section with a dense fixing force to prevent the dental implant from loosening due to the inverse torque derived from the mastication and allow the second section to be firmly and densely wedged into the alveolar bone. Therefore, the present invention increases the steadiness of the combination between the dental implant and the alveolar bone and attains a high combining stability.

While we have shown and described the embodiment in accordance with the present invention, it should be clear to those skilled in the art that various modifications may be made in further embodiments described without departing from the spirit and scope of the invention.

What is claimed is:

1. A dental implant with high combining stability comprising a shank and a threaded section spirally disposed on said shank, wherein a first end and a second end opposite to said first end are respectively formed at two sides of said shank;
wherein said shank includes a first section extending from said first end toward said second end and a second section connecting said first section and extending to said second end, said first section and said second section being connected at a connecting part, and a shank diameter of said connecting part being smaller than a shank diameter of said second section.

2. The dental implant as claimed in claim 1, wherein a third section is disposed between said first end and said first section, and a plurality of small threads are spirally disposed on said third section.

3. The dental implant as claimed in claim 2, wherein said third section and said first section is connected at a join part, and a maximum shank diameter of said third section is larger than a shank diameter of said join part.

4. The dental implant as claimed in claim 1, wherein said first section includes a first portion with a gradual-enlarging shank diameter and a second portion with a gradual-contracting shank diameter disposed between said first portion and said second section, said first portion and said second portion being connected at a junction part, a shank diameter of said junction part being larger than shank diameters of said first portion and said second portion.

5. The dental implant as claimed in claim 2, wherein said first section includes a first portion with a gradual-enlarging shank diameter connected to said third section and a second portion with a gradual-contracting shank diameter disposed between said first portion and said second section, said first portion and said second portion being connected at a junction part, a shank diameter of said junction part being larger than shank diameters of said first portion and said second portion.

6. The dental implant as claimed in claim 3, wherein said first section includes a first portion with a gradual-enlarging shank diameter connected to said third section and a second portion with a gradual-contracting shank diameter disposed between said first portion and said second section, said first portion and said second portion being connected at a junction part, a shank diameter of said junction part being larger than shank diameters of said first portion and said second portion.

7. The dental implant as claimed in claim 1, wherein a shank diameter of said first section is gradually decreased toward a direction of said second section.

8. The dental implant as claimed in claim 1, wherein a shank diameter of said second section is gradually increased toward a direction of said second end.
